(19) United States
(12) Patent Application Publication
(10) Pub. No.: US 2023/0159733 A1
(43) Pub. Date: May 25, 2023

(54) METHOD FOR INDUCING GREATER WETTABILITY OF CONTACT LENS COMPOSITIONS DURING MOLDING

(71) Applicant: Gelest, Inc., Morrisville, PA (US)

(72) Inventors: Barry C. ARKLES, Pipersville, PA (US); Jonathan D. GOFF, Philadelphia, PA (US); Liana D. WUCHTE, Wenonah, NJ (US)

(21) Appl. No.: 17/990,912

(22) Filed: Nov. 21, 2022

Related U.S. Application Data
(60) Provisional application No. 63/281,927, filed on Nov. 22, 2021.

(51) Int. Cl. C08L 23/12

(52) U.S. Cl. CPC C08L 23/12; C08L 2205/03

(57) ABSTRACT

A method for producing a contact lens having a water contact angle below about 90° involves preparing a molding resin comprising a polyether modified polyolefin; forming the molding resin into a mold; preparing a contact lens composition; filling the contact lens composition into the mold; and polymerizing the contact lens composition to form a contact lens. A method of inducing water contact angle below 90° and improved surface wettability of a contact lens involves cast polymerizing a mixture of monomers in a mold formed from a molding resin containing a polyether modified polyolefin to form a contact lens having a water contact angle of less than about 90°. Single-use molds for contact lens manufacture are also provided.

### CROSS-REFERENCE TO RELATED APPLICATIONS

This application claims priority to U.S. Provisional Pat. Application No. 63/281,927, filed Nov. 22, 2021, the disclosure of which is herein incorporated by reference in its entirety.

### BACKGROUND OF THE INVENTION

In the predominant current high-volume hydrogel and silicone-modified hydrogel (SiHy) contact lens manufacturing technology, a mixture of unsaturated monomers chosen for their ability to provide mechanical properties, oxygen permeability, and user comfort are cast polymerized in single-use polyolefin molds. These molds typically contain multiple cavities (such as four or more cavities). In production, the monomer mixture or composition in liquid form is filled into the polyolefin molds and then polymerized to form the lens using UV light irradiation or thermal energy.

Following polymerization, the lenses are removed from the mold (delensed) and the mold is discarded. After delensing and prior to use, the lenses are typically extracted to remove residual monomers; initiator byproducts are then hydrated in a saline or buffered saline solution. SiHy lenses must then be modified by one or more additional intermediate processing steps due to intrinsic limitations of the surface characteristics of the as-molded lens. The surface wettability of unmodified SiHy lenses, characterized by high water contact angles, is poor. Surface wettability is not only an important parameter in short-term user comfort, but also has an important role in protein adsorption and other factors which affect physiological behavior. Consequently, after delensing, surface wettability is induced by oxygen plasma treatment or achieved by a surface coating process. In addition to the inefficiencies caused by the additional manufacturing step, the surface modification frequently lacks stability, and its effectiveness is diminished during storage or use. An alternate approach is to incorporate polymeric species such as polyvinylpyrolidinone into the lens composition matrix, but this has limited application both due to limited solubility in the lens monomer composition and reduction of mechanical and optical properties in the polymerized final lens. Overviews of silicon hydrogel from a materials and process technology perspectives are provided by Musgrave (“Contact Lens Materials - A Materials Science Perspective Materials,” Materials; 12, 261 (2019)); Goff (“Applications of Hybrid Polymers Generated by Living Anionic Ring Opening Polymerization Molecules,” Macromolecules 26, 2755 (2021)) and N. Efron (Chapter 5-Soft-Lens-Manufacture, in Contact-Lens-Practice 3rd edition, Elsevier p 61-67 (2018)).

### SUMMARY OF THE INVENTION

In one aspect of the disclosure, provided is a method of producing a contact lens having a water contact angle below about 90° comprising:
(a) Preparing a molding resin comprising a polyether modified polyolefin;
(b) Forming the molding resin into a mold;
(c) Preparing a contact lens composition;
(d) Filling the contact lens composition into the mold; and
(e) Polymerizing the contact lens composition to form a contact lens.

In another aspect of the disclosure, provided is a method of inducing water contact angle below 90° and improved surface wettability of a contact lens comprising cast polymerizing a mixture of monomers in a mold formed from a molding resin containing a polyether modified polyolefin to form a contact lens having a water contact angle of less than about 90°.

In a further aspect of the disclosure, provided is a single-use mold for contact lens manufacture, wherein the mold comprises a polyether modified polyolefin composition.

### DETAILED DESCRIPTION OF THE INVENTION

The disclosure relates to a method of producing SiHy contact lenses with low water contact angle and surface wettability which utilizes a modified polyolefin mold that contains grafted or copolymerized polyethers. Surfaces with contact angles below about 90° are generally considered wettable and for contact lens applications contact angles below about 70° are preferred. Accordingly, for the purposes of this disclosure, the phrase “low water contact angle” may be understood to refer to contact angles below about 90°, preferably below about 80°, more preferably below about 70°, even more preferably below about 65°. By employing these modified polyolefin molds and specific mixtures of silicone-containing monomers, contact lenses with desirable properties can be achieved after delensing and upon hydration without any intermediate processing steps such as oxygen plasma treatment or surface coating. Preferably, the mixture of monomers allows formation of polymers with polar pendant groups or bottle-brush structures. The most preferred polar groups are those capable of hydrogen bonding, which can be substituents in any of the monomers in the monomer mixture used to cast the contact lens. In most preferred embodiments, the mixture contains a polar monomer which is also a silicon-containing monomer that, after polymerization, possesses a pendant group capable of hydrogen bonding.

### Single-Use Molds for Contact Lens Manufacture

The molds for contact lens manufacture according to aspects of the disclosure are formed from contact lens mold compositions (molding resins) which contain a polyether modified polyolefin. Appropriate polyolefins according to the disclosure include polypropylene, copolymers of propylene with ethylene or other olefins, polymethylpentene, and polyethylene; polypropylene and polymethylpentene are preferred. These materials are desirable resins for the high-speed molds for contact lenses due to their release properties which allow debonding of the contact lens, their high temperature properties which are sufficient to allow thermal cure, reasonable transparency which allows UV cure, hydrolysis resistance, and economics.

These polyolefins are modified by the introduction of polyethers to produce the polyether modified polyolefins. The modification may be accomplished, for example, by incorporation of the polyether as a comonomer in the base resin, such as a copolymer of propylene and an allyl terminated polyether. Alternately, the modified base molding resin may be formed by reacting a polyether with a maleated graft polymer of a polypropylene. In other embodiments, the modified polyolefin may be prepared by the esterification of a carboxylic acid group-modified polyolefin base copolymer with a polyether, in which the carboxylic acid group is introduced by copolymerization or grafting of an acrylate monomer.

In a preferred embodiment, the polyether modified polyolefin is blended with an unmodified polyolefin resin. For example, a polyether modified polypropylene may be blended with a standard polypropylene or other polyolefin resin (such as a polypropylene copolymer, polyethylene, or polymethylpentene) at a level sufficient to achieve the desired water contact angle of the contact lens. In one embodiment, a maleated polyolefin reacted with a polyether may be compounded by extrusion into a base polymer at an amount of about 5 to 20 wt%. Preferably, for compatibility, the base polymer used for compounding is the same as the polyolefin in the polyether modified polyolefin. However, it is believed that random copolymers may contribute to slight reduction in contact angle. In preferred embodiments, the polyether modified polyolefin is compounded with a polypropylene homopolymer or copolymer. It is also within the scope of the disclosure to form the mold using just the polyether modified polyolefin.

In one embodiment, the molding resins according to the disclosure may be readily produced by the reaction of maleated polyolefins, such as maleated polypropylene. As used herein, the term “maleated polypropylene” generally refers to the reaction product formed by grafting maleic anhydride, preferably by covalent bonding, to the backbone of polypropylene which can contain up to 10% of a comonomer such as ethylene. Melt grafting methods for maleation of polyolefins are well known and have been reviewed (seem for example, P. B. M. Janssen, “Reactive Extrusion Systems” Marcel Dekker, p. 169-178 (2004)). Maleated polyolefins are commercially available, such as from Dow (Fusabond), SI Group (formerly Chemtura, Polybond), Westlake (Epolene), Eastman (G Polymer), LyondellBasell (Plexar), and Mitsubishi Chemical (Modic), among others, and are most commonly used as adhesion promoters, tie-layers or compatibilizers.

It is further within the scope of the disclosure to react/combine the maleated polyolefin or other polyether modified polyolefin (optionally blended with an unmodified polyolefin resin) with a hydrophilic additive, such as a polyether amine, methoxypolyethylene glycol, or other polyethylene glycols with a free hydroxyl group at one termination and an alkyl group such as butyl at the other termination, in amounts ranging from about 25% to about 100% molar equivalents, with a preferred range of 50-75% based on the amount of maleated polyolefin. Put another way, if the polyether modified polyolefin is a grafted or copolymerized polyolefin contain an anhydride or carboxylic acid group, the hydrophilic additive may be present in an amount about 0.25 to 1.00 molar equivalents relative to the anhydride or carboxylic acid content of the grafted or copolymerized polyolefin. A presently preferred polyether amine is an amine-terminated PEO-PPO copolymer. Other additives known in the art, such as, but not limited to process aids, oxidation inhibitors, and release agents may additionally be incorporated.

The polyether modified polyolefins according to aspects of the disclosure may include, without limitation, regular copolymers, graft copolymers, and blends of these materials with unmodified polyolefins. For example, the polyether reaction of a maleated graft copolymer of polypropylene with an alpha-amine terminated PEO-PPO copolymer with omega methyl termination may be replaced with an alpha-hydroxy, omega-methyl terminated polyethylene oxide homopolymer. The degree of polymerization of the polyether modified materials described herein may be from about 2 to about 50, with a preferred range of about 6 to about 20. The reaction products of amine terminated polyethers with maleated polypropylene may be referred to as maleamate or maleamic acid modified polypropylene. The reaction products of hydroxyl terminated polyethers with maleated polypropylene may be referred to as maleate ester modified polypropylene.

Once produced, the contact lens mold composition or resin, containing the polyolefin modified polyolefin base polymer and optionally other components, is formed into molds using known methods, typically by injection molding, and then used for producing contact lenses, as described in further detail below. As previously explained, the resulting contact lenses have water contact angle below about 90°, preferably below about 85°, more preferably below about 80°, even more preferably below about 75°, even more preferably below about 70°, and even more preferably below about 65°. It is within the scope of the invention for the mold to contain many cavities, such as four or more cavities, for simultaneous production of multiple contact lenses.

As an example of a single-use contact lens mold according to the disclosure, commercially available Polybond 7200, a 1.5-1.9 weight % maleic anhydride grafted polypropylene, may be employed as the polyether modified polyolefin. This material may be reacted in the melt state (such as by utilizing a co-rotating twin screw extruder) with an amine terminated PEO-PPO copolymer (MW ~1000 daltons) at a molar equivalent of 25%. This reacted graft may be compounded at 20 weight % with a standard polypropylene (such as the commercially available Pinnacle Polymers 1120H), and then molded into plaques for analysis. It is noted that flat plaques rather than contact lens molds are employed for testing and analysis purposes. It has been observed that the water contact angle of the Pinnacle polypropylene base polymer was measured at 96° whereas the water contact angle of the Pinnacle polypropylene base polymer compounded with the modified graft polymer was 79°.

### Contact Lens Composition

The composition of the contact lens is important for achieving optimum performance. The mixture of monomers used to form the contact lens typically contains at least three components: a base monomer (such as, but not limited to dimethylacrylamide (DMA) or hydroxyethylmethacrylate (HEMA)), a silicone-containing macromer (such as, but not limited to a low molecular weight methacryloxypropyl terminated polydimethylsiloxane (MPDMS) DP~10 (Gelest MCR-M11)), and a cross-linker (such as, but not limited to ethylene glycol dimethacrylate (EGDMA)). Preferably, the silicone-containing macromer has at least three polyethyleneoxy groups (PEGs). In a preferred embodiment, an additional monomer containing a polyether segment bonded to a siloxane replaces a portion or all of the silicone-containing macromer. Examples of such macromers are described in U.S. Pat. No. 10,669,294, in which the polyether comonomer content is from 10 to 100%, and in U.S. Pat. No. 8,772,367. These known macromers are not used to make contact lenses on a commercial basis. Although the chemistry is different, each of these compositions contain two more polyethyleneoxy groups (PEGs).

It is known that polyolefin surfaces are extremely hydrophobic. Polypropylene has observed water contact angles between 105-110°, although commercial grades which contain additives or comonomers are more typically between 96-103°, and a critical surface tension of 31 mN/m. Under the cast molding conditions employed in conventional contact lens manufacture, these properties cause an accumulation of hydrophobic moieties at the interface with the mold, which in turn leads to a high contact angle and poor wettability of the contact lens. While not wishing to be bound by theory, it is believed that the surface of the modified polyolefin molds described herein are enriched with polyether groups compared to the bulk. As a result, the mixture of monomers in the contact lens composition has less tendency to accumulate hydrophobic moieties at the interface with the polypropylene mold. In preferred embodiments, a mixture of monomers containing polar groups, and most preferably polyether groups or other groups capable of hydrogen bonding, are included in the reactive monomer mix. Materials of this description are generally more hydrophilic. The preferred monomers are believed to adsorb in enriched concentrations at the interface and this is particularly favored with polyether containing monomers having the capability of hydrogen bonding. A mechanism for enrichment of polar groups at the mold interface is not limited to the reactive monomers. In the case of polymerized monomers containing pendant polyether groups, the polyether groups can reptate or accommodate by orienting at the interface with the modified polyolefin mold.

To be clear, the molds formed from the compositions described herein are different than those obtained by applying a surface-active agent to a mold. The application of a chemical species to a mold material would result in extra manufacturing steps in the application and introduce concerns about migration and contamination of the lens with the surface-active agent. In contrast, the contact lens mold compositions described herein are consistent with current manufacturing technology for cast molding of contact lenses, which rely on the optical, thermal, release, and mechanical properties, as well as the economics of polyolefins. While it is probable that other resins with higher critical surface tensions could induce greater hydrophilicity, they likely would have reduced release properties. While not considering lens surface wettability, U.S. Pat. No. 9,102,110 demonstrates the issues involved with polyvinyl alcohol molds in terms of mold-opening and delensing. More typically mold materials are evaluated for their ability to release during the delensing process or to form smooth surfaces as described, for example, in JP 2004299222 (2004), in which glycerin monostearate containing polypropylene is employed.

### Methods of Forming Contact Lenses

Further aspects of the disclosure relate to a method of producing a contact lens having low water contact angle, more specifically below about 90°, preferably less than about 80°, more preferably less than about 70°, even more preferably less than 65°, which enables surface wettability, as previously described. The method involves first preparing a molding composition (resin) comprising a polyether modified polyolefin as previously described. The molding resin may contain only the polyether modified polyolefin or may contain a blend containing an unmodified polyolefin into which the polyether modified polyolefin is compounded, and may further contain additives, as described above.

The molding resin is formed into a mold containing cavities using conventionally known methods, such as by injection molding.

In a subsequent step, the method involves preparing a contact lens composition, such as a composition containing a base monomer, a silicon-containing monomer, and a cross-linker, as previously described. Methods for forming such compositions are well known in the art and need not be described. Preferably, the silicon-containing monomer has at least two polyethyleneoxy groups (PEGs). The contact lens composition containing a mixture of monomers in liquid form is then filled into the cavities of the mold using conventional methods, and polymerized to form the contact lenses. Polymerization may be effected by UV irradiation or thermally using heat, with a photoinitiator or radical initiator added to the contact lens compositions, respectively. Finally, the contact lenses are removed from the cavities (delensed) and the mold is discarded. Application of water, alone or in combination with alcohol or surfactant may be utilized to assist in releasing the lens from the mold.

As previously explained, in contrast with known methods, no surface treatment or coating process is performed on the contact lenses after delensing. Rather, the observed superior properties of low water contact angle and improved surface wettability, as described above, are the result of the composition used to form the molds in combination with the contact lens composition. As previously explained, the resulting contact lenses have water contact angle below about 90°, preferably below about 85°, more preferably below about 80°, even more preferably below about 75°, even more preferably below about 70°, and even more preferably below about 65°.

The use of the molding resins described herein has a dramatic effect on the water contact angle of the resulting contact lenses. The extent of the effect varies not only with the material used to form the molding resin, but also with the specific silicon-containing monomer used to form the contact lens. For example, the water contact angle of macromers formed from a composition containing α-methacryloxy, ω-butyl terminated polydimethylsiloxane homopolymer and polymerized on substrates containing polyether maleamate modified polypropylene decreased to 99° relative to a water contact angle of 114° for analogous macromers polymerized on an unmodified polypropylene substrate.

When the silicone-containing macromer in the contact lens composition contained a diethyleneoxide (PEG) substitution, a more dramatic decrease in water contact angle, indicating greater wettability, is observed. For example, macromers prepared from a composition containing α-methacryloxy, ω-butyl terminated poly(methoxydiethylene-oxypropyl)-methylsiloxane) homopolymer exhibited a water contact angle of 116° when polymerized on unmodified polypropylene but water contact angles of 72° and 59°, respectively, when polymerized on two different maleamate modified polypropylene substrates. Similarly, macromers prepared from a composition containing α-methacryloxy ω-butyl terminated 50% (methoxydiethylene-oxypropyl)-methylsiloxane) 50% dimethylsiloxane copolymer exhibited a water contact angle of 109° when polymerized on unmodified polypropylene but water contact angles of 74° and 64°, respectively, when polymerized on two different maleamate modified polypropylene substrates. Further, macromers prepared from a composition containing α -methacryloxy ω-butyl terminated 25% (methoxydiethylene-oxypropyl)-methylsiloxane) 75% dimethylsiloxane copolymer exhibited a water contact angle of 97° when polymerized on unmodified polypropylene but water contact angles of 73° and 65°, respectively, when polymerized on two different maleamate modified polypropylene substrates.

Similar results are observed for macromers polymerized on maleate ester modified polypropylene substrates. Specifically, the water contact angle of macromers formed from a composition containing α-methacryloxy, ω-butyl terminated polydimethylsiloxane homopolymer and polymerized on substrates containing polyether maleate ester modified polypropylene decreased to 100° relative to a water contact angle of 114° for analogous macromers polymerized on unmodified polypropylene.

When the silicone-containing macromer in the contact lens composition contained a diethyleneoxide (PEG) substitution, a more dramatic decrease in water contact angle, indicating greater wettability, is observed. For example, macromers prepared from a composition containing α-methacryloxy ω-butyl terminated 50% (methoxydiethylene-oxypropyl)-methylsiloxane) 50% dimethylsiloxane copolymer exhibited a water contact angle of 109° when polymerized on unmodified polypropylene but a water contact angle of 95° when polymerized on a polyether maleate ester modified polypropylene substrate. Further, macromers prepared from a composition containing α-methacryloxy ω-butyl terminated 25% (methoxydiethylene-oxypropyl)-methylsiloxane) 75% dimethylsiloxane copolymer exhibited a water contact angle of 97° when polymerized on unmodified polypropylene but a water contact angle of 94° when polymerized on the polyether maleate ester modified polypropylene substrate.

A further aspect of the disclosure relates to a method of inducing low water contact angle and improved surface wettability of contact lenses formed by polymerization of mixtures of monomers by cast polymerization in molds composed of polyether modified polyolefins as previously described. As previously explained, the resulting contact lenses have water contact angle below about 90°, preferably below about 85°, more preferably below about 80°, even more preferably below about 75°, even more preferably below about 70°, and even more preferably below about 65°.

Additionally, the disclosure provides a single-use mold for contact lens manufacture, wherein the mold comprises a polyether modified polyolefin composition as described above. The mold may contain multiple cavities as known in the art, such as four or more cavities. Contact lenses which are prepared using these molds, particularly from monomer mixtures described above, have low water contact angle, as previously described.

The invention will now be described in connection with the following, non-limiting examples.

### Example 1: Preparation of Polyether Maleamate Modified Base Molding Composition

Polybond 7200 (SI Group), a 1.5-1.9 weight % maleic anhydride grafted polypropylene, was selected for the base molding resin. Utilizing a 16 mm Haake (25 L/D) extruder, the dry Polybond 7200 was reacted in the melt state with an amine terminated PEO-PPO copolymer (MW ~1000 daltons, Huntsman Jeffamine M1000) at a molar equivalent of 25%. This reacted graft was compounded at 20 weight % with a standard polypropylene, Pinnacle Polymers 1120H, and then molded into plaques. The water contact angle of the Pinnacle polypropylene base polymer was measured at 96° and the water contact angle of the Pinnacle polypropylene base polymer compounded with the modified graft polymer was 79°.

### Example 2: Preparation of Contact Lenses

A typical base mixture of reactive monomers with the following components was used as a control: MCR-M11 silicone macromer, methacryloxypropyltris(trimethylsiloxy)silane, dimethylacrylamide in ~1:1:2 ratio with the addition of PEG200DMA as a crosslinker, and 2-hydroxy-2-methylpropiophenone (Darocur 1172) as a photoinitiator. The mixture was polymerized on the plaques described in Example 1 and the water contact angle of the cured films were measured. The contact angle of films of the polymerized contact lens composition showed a contact angle of ~114° on the unmodified control (Pinnacle propylene base polymer) compared to ~99° for the modified material prepared in Example 1. In this case the reactive monomer mix with MCR-M11 shows the benefit of using the mold resin of example 1. Note that it is reduced from 114° to 99°, but 99° is still above 90° and therefore is not low enough to achieve acceptable contact lens wettability. This mix with MCR-M11 is a control for Example 3 which replaces the MCR-M11 with essentially a PEG modified MCR-M11. This demonstrates the ability of the polyether modified polyolefin to induce greater surface wettability to the contact lenses.

### Example 3: Preparation of Contact Lenses

Contact lenses were prepared as described in Example 2 except that the MCR-M11 was substituted by the copolymer generally described in U.S. Pat. No. 10,669,294 with a DP of 10 and containing ~ 25 mole % comonomer units with 2 PEG units on the pendant as depicted in Structure 1.

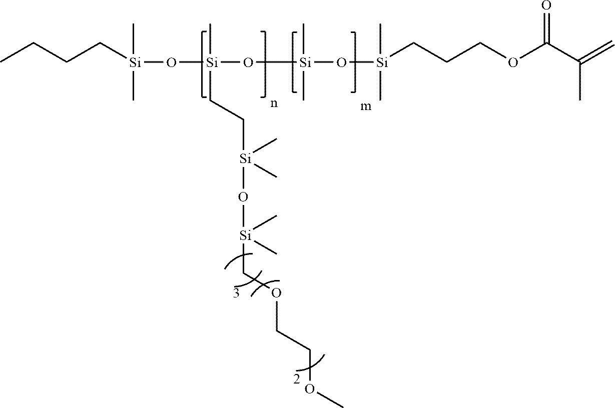

The resulting mixture had a contact angle of ~65° when polymerized on the polyether modified plaques as described in Example 1 compared to ~97° when polymerized on the unmodified polypropylene control. Similar but slightly higher contact angles of ~74° were observed in an analogous example in which 50% molar equivalents of the maleated polypropylene was compounded at 10% loading rather than 25% molar equivalents at 20% loading as in Example 1.

### Example 4: Preparation of Maleamic Acid Modified Polypropylene - Polypropylene Blend

A blend was produced in a two-stage process. Utilizing a 27 mm Leistritz (40 L/D) counter-rotating twin screw extruder, a mechanical pellet blend of 80% polypropylene homopolymer (PP), 20% Pinnacle 1120H with a 1.5-1.9 wt % maleic anhydride grafted polypropylene (SI Group Polybond 7200) was melt compounded at ~210° C. and pelletized. The dried pelletized alloy was fed again into a 16 mm Haake TSE (25 L/D) extruder. A room temperature liquid feed with 0.5 molar equivalents of α-amine, ω-methyl terminated polypropylene oxide - polyethylene oxide copolymer MW 1000 (Huntsman Jeffamine M1000) was injected downstream in the extruder by means of a syringe pump. The pelletized extrudate was dried. Analysis indicated the formation of reaction products, primarily the maleamic acid derivative of polypropylene. This material was then formed into plaques. The sessile water contact angle of the plaques were measured at 62° ± 3°. Control polypropylene plaques exhibited contact angles of 96°.

### Example 5: Preparation of Methyl-PEG Ether Modified Maleic Acid Modified Polypropylene -Polypropylene Blend

Under similar conditions to Example 4, α-hydroxy, ω-methyl terminated polyethylene oxide was substituted for α-amine, ω-methyl terminated polypropylene oxide -polyethylene oxide. An alloy of PP homopolymer, Pinnacle 1120H with 1.5-1.9 wt % maleic anhydride grafted polypropylene (SI Group Polybond 7200) was melt compounded and pelletized under the same conditions as in Example 1. Methoxy polyethylene glycol (TCI America MPEG1000) was heated to 60° C. and fed as a liquid at 0.25 molar equivalents downstream in the extrusion process. A melt temperature of 210-230° was maintained at a screw speed of 200 rpm. This modified polypropylene was compounded at 10 wt % loading in Polybond 7200. This material was formed into plaques and the sessile drop water contact angle was measured to be 77°.

### Example 6: Induction of Surface Wettability of Compositions With Utility to Form Contact Lenses

Four compositions corresponding to those conventionally utilized to form contact lenses were cast onto modified polypropylene plaques and polymerized by UV radiation. Each of the evaluated compositions contained 21.5% silicone macromer; 21.5% (3-methacryloxy-2-hydroxypropoxypropyl)methylbis(trimethylsiloxy)silane; 54.0% dimethylacrylamide; 2.0% bis methacrylate ester of polyethylene oxide MW 200, and 1.0% Darocur 1172 photoinitiator.

The four silicone macromers included: α-methacryloxy, ω-butyl terminated polydimethylsiloxane; α-methacryloxy, ω-butyl terminated poly(methoxydiethylene-oxypropyl)-methylsiloxane) homopolymer; α-methacryloxy ω-butyl terminated 50% (methoxydiethylene-oxypropyl)-methylsiloxane) 50% dimethylsiloxane copolymer; and α -methacryloxy ω-butyl terminated 25% (methoxydiethylene-oxypropyl)-methylsiloxane) 75% dimethylsiloxane copolymer. The water contact angle of films prepared from these methacrylate-terminated macromers cast against unmodified polypropylene and two modified polypropylene substrates having the components shown below and prepared in the same manner as described in Example 1 were measured and summarized in the Table below. In all cases the water contact angle was lower on the modified polypropylene compared to the unmodified substrate. The macromers with diethylene oxide (PEG) substitution demonstrated a more dramatic decrease in water contact angle, indicating a greater wettability.

| Polypropylene Plaques | Water Contact Angle of Methacrylate Terminated Macromers Cast Films Against Maleamate Modified PP Substrates (± 3°) | | | |
|---|---|---|---|---|
| | (Dimethylsiloxane homopolymer) | Poly(methoxydiethylene -oxypropyl)-methylsiloxane) homopolymer | (Methoxydiethylene -oxypropyl)-methylsiloxane 50% dimethylsiloxane 50% copolymer | (Methoxydiethylene -oxypropyl)-methylsiloxane 25% dimethylsiloxane 75% copolymer |
| Unmodified Polypropylene Control | 114 | 116 | 109 | 97 |
| PP(90%) -PPMA(10%) -AminoPEG(0 \. 5M) | | 72 | 74 | 73 |
| PP(80%) -PPMA(20%) -AminoPEG(0 \. 25M) | 99 | 59 | 64 | 65 |

### Example 7: Preparation of Modified Maleamate Acid Modified Polypropylene

A polypropylene polymer containing a 1.0-1.2 wt % maleic acid from Mitsubishi Chemical was modified at 100% molar equivalents of α-amine, ω-methyl terminated polypropylene oxide - polyethylene oxide copolymer (MW 1000) under the same general conditions as Example 1. The modified graft copolymer was separately re-extruded at 50 wt % with a polypropylene homopolymer (Novatek MA3 Mitsubishi Chemical Corp.) and a random propylene-ethylene copolymer (Wintec WMG03 Japan Polypropylene Corp.). The uncompounded homopolymer and random copolymer both exhibited water contact angles of ~97°. The contact angle of the 50% homopolymer blend was 89° whereas the water contact angle of the 50% copolymer blend was 82°. Infrared analysis indicated the reaction product to be primarily a polyether maleamic acid with observable but unquantified polyether maleimide.

### Example 8: Induction of Surface Wettability Compositions with Utility to Form Contact Lenses

As in Example 6, three compositions corresponding to those conventionally utilized to form contact lenses were cast onto modified polypropylene plaques and polymerized by UV radiation. Each of the evaluated compositions contained 21.5% silicone macromer; 21.5% (3-methacryloxy-2-hydroxypropoxypropyl)methylbis(trimethylsiloxy)silane; 54.0% dimethylacrylamide; 2.0% bis methacrylate ester of polyethylene oxide MW 200 (EGDMA 200), and 1.0% Darocur 1172 photoinitiator.

The three silicone macromers included: α-methacryloxy, ω-butyl terminated polydimethylsiloxane; α-methacryloxy ω-butyl terminated 50% (methoxydiethylene-oxypropyl)-methylsiloxane) 50% dimethylsiloxane copolymer; and α -methacryloxy ω-butyl terminated 25% (methoxydiethylene-oxypropyl)-methylsiloxane) 75% dimethylsiloxane copolymer. The water contact angle of films prepared from these methacrylate-terminated macromers cast against unmodified polypropylene and a 10% methyl-PEG ether modified maleic acid modified polypropylene - 90% polypropylene blend as described in Example 5. As shown in the Table below, the contact angle of films of the polymerized contact lens composition showed a contact angle of ~114° on the unmodified control compared to ~100° for the modified material. When the concentration of methyl-PEG ether modified maleic acid modified polypropylene was increased to 20% a further reduction of water contact angle of ~ 10° films from other contact lens formulations was generally observed.

| Polypropylene Plaques | Water Contact Angle of Methacrylate Terminated Macromer Films Cast Against Maleate ester modified PP Substrates (± 3°) | | |
|---|---|---|---|
| | (Dimethylsiloxane homopolymer) | (Methoxydiethyleneoxypr-opyl)-methylsiloxane 50% dimethylsiloxane 50% copolymer | (Methoxydiethyleneoxypr opyl)-methylsiloxane 25% dimethylsiloxane 75% copolymer |
| Unmodified Polypropylene Control | 114 | 109 | 97 |
| PP(90%) -PPMA(10%) -mPEG(0.25 M) | 100 | 95 | 94 |

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A method of producing a contact lens having a water contact angle below about 90° comprising:
(a) Preparing a molding resin comprising a polyether modified polyolefin;
(b) Forming the molding resin into a mold;
(c) Preparing a contact lens composition;
(d) Filling the contact lens composition into the mold; and
(e) Polymerizing the contact lens composition to form a contact lens.

2. The method according to claim 1, wherein the polyolefin in the molding resin comprises at least one of a polypropylene homopolymer, a polypropylene copolymer, a polyethylene homopolymer, and polymethylpentene.

3. The method according to claim 1, wherein step (a) comprises preparing a copolymer of a polyether and the polyolefin.

4. The method according to claim 1, wherein step (a) comprises reacting a polyether with a maleated graft polymer of a polyolefin.

5. The method according to claim 1, wherein the molding resin comprises a blend of the polyether modified polyolefin and an unmodified polyolefin resin.

6. The method according to claim 5, wherein the polyether modified polyolefin is compounded into the unmodified polyolefin resin in an amount of about 5 to 20 weight percent.

7. The method according to claim 1, wherein the molding resin further comprises a hydrophilic additive selected from a polyether amine and a methoxypolyethylene glycol.

8. The method according to claim 7, wherein the polyether modified polyolefin is a grafted or copolymerized polyolefin containing an anhydride or carboxylic acid group, and wherein the hydrophilic additive is present in an amount of about 0.25 to 1.00 molar equivalents relative to the anhydride or carboxylic acid content of the grafted or copolymerized polyolefin.

9. The method according to claim 1, wherein the contact lens composition comprises a base monomer, a silicone-containing macromer, and a cross-linker.

10. The method according to claim 9, wherein the silicone-containing macromer contains at least two polyethyleneoxy groups (PEGs).

11. The method according to claim 1, wherein step (e) comprises applying UV irradiation or heat to effect the polymerization.

12. A method of inducing water contact angle below 90° and improved surface wettability of a contact lens comprising cast polymerizing a mixture of monomers in a mold formed from a molding resin containing a polyether modified polyolefin to form a contact lens having a water contact angle of less than about 90°.

13. The method according to claim 12, wherein the polyolefin in the molding resin comprises at least one of a polypropylene homopolymer, a polypropylene copolymer, a polyethylene homopolymer, and polymethylpentene.

14. The method according to claim 12, wherein the molding resin comprises a copolymer of a polyether and the polyolefin.

15. The method according to claim 12, wherein the molding resin comprises a polyether reacted with a maleated graft polymer of a polyolefin.

16. The method according to claim 12, wherein the molding resin comprises a blend of the polyether modified polyolefin and an unmodified polyolefin resin.

17. The method according to claim 12, wherein the polyether modified polyolefin is compounded into the unmodified polyolefin resin in an amount of about 5 to 20 weight percent.

18. The method according to claim 12, wherein the molding resin further comprises a hydrophilic additive selected from a polyether amine and a methoxypolyethylene glycol.

19. The method according to claim 18, wherein the polyether modified polyolefin is a grafted or copolymerized polyolefin containing an anhydride or carboxylic acid group, and wherein the hydrophilic additive is present in an amount of about 0.25 to 1.00 molar equivalents relative to the anhydride or carboxylic acid content of the grafted or copolymerized polyolefin.

20. The method according to claim 12, wherein the mixture of monomers comprises a base monomer, a silicone-containing macromer, and a cross-linker.

21. The method according to claim 20, wherein the silicone-containing macromer contains at least two polyethyleneoxy groups (PEGs).

22. A single-use mold for contact lens manufacture, wherein the mold comprises a polyether modified polyolefin composition.

23. The single-use mold according to claim 22, wherein the polyolefin in the composition comprises at least one of a polypropylene homopolymer, a polypropylene copolymer, a polyethylene homopolymer, and polymethylpentene.

24. The single-use mold according to claim 22, wherein the composition comprises a copolymer of a polyether and the polyolefin.

25. The single-use mold according to claim 22, wherein the composition comprises a polyether reacted with a maleated graft polymer of a polyolefin.

26. The single-use mold according to claim 22, wherein the composition comprises a blend of the polyether modified polyolefin and an unmodified polyolefin resin.

27. The single-use mold according to claim 26, wherein the polyether modified polyolefin is compounded into the unmodified polyolefin resin in an amount of about 5 to 20 weight percent.

28. The single-use mold according to claim 22, wherein the composition further comprises a hydrophilic additive selected from a polyether amine and a methoxypolyethylene glycol.

29. The single-use mold according to claim 28, wherein the polyether modified polyolefin is a grafted or copolymerized polyolefin containing an anhydride or carboxylic acid group, and wherein the hydrophilic additive is present in an amount of about 0.25 to 1.00 molar equivalents relative to the anhydride or carboxylic acid content of the grafted or copolymerized polyolefin.

30. The single-use mold according to claim 23, wherein a contact lens produced from the mold has a water contact angle of less than about 90°.

31. The single-use mold according to claim 30, wherein the contact lens is formed from a composition comprising a base monomer, a silicone-containing macromer, and a cross-linker.

32. The single-use mold according to claim 31, wherein the silicone-containing macromer contains at least two polyethyleneoxy groups (PEGs).
